(19) United States
(12) Patent Application Publication
(10) Pub. No.: US 2025/0266459 A1
(43) Pub. Date: Aug. 21, 2025

(54) SECONDARY BATTERY ELECTRODE BINDER AND USE OF SAME

(71) Applicant: TOAGOSEI CO., LTD., Tokyo (JP)

(72) Inventors: Kenichi YOSHIMORI, Nagoya-shi (JP); Naohiko SAITO, Nagoya-shi (JP); Takashi HASEGAWA, Nagoya-shi (JP)

(73) Assignee: TOAGOSEI CO., LTD., Tokyo (JP)

(21) Appl. No.: 18/857,018

(22) PCT Filed: Apr. 3, 2023
(86) PCT No.: PCT/JP2023/013870

§ 371 Date: Oct. 15, 2024

(30) Foreign Application Priority Data
Apr. 27, 2022 (JP) 2022-072904

(51) Int. Cl. H01M 4/62; H01M 4/134; H01M 4/38; H01M 10/0525

(52) U.S. Cl. CPC H01M 4/622; H01M 4/134; H01M 4/386; H01M 10/0525

(57) ABSTRACT

The present invention provides a binder for a secondary battery electrode, capable of improving the toughness of a binder applied film after immersion in an electrolyte solution, the resistance of a secondary battery electrode mixture layer against the electrolyte solution, and the cycle characteristic of a secondary battery. The binder for a secondary battery electrode includes a carboxyl group-containing crosslinked polymer or a salt thereof, in which at least a part of the carboxyl group is a functional group used to couple with an organic compound having two or more cationic groups.

### TECHNICAL FIELD

The present invention relates to a binder for a secondary battery electrode, and use thereof.

### BACKGROUND ART

As secondary batteries, various power storage devices such as a nickel hydrogen secondary battery, a lithium ion secondary battery, and an electric double-layer capacitor have been put into practical use. An electrode used for these secondary batteries is manufactured in such a way that, for example, a composition for forming an electrode mixture layer including an active material, a binder, and the like is applied and dried on a current collector. For example, in a lithium ion secondary battery, an aqueous binder containing styrene butadiene rubber (SBR) latex and carboxymethyl cellulose (CMC) is used as a binder that is used for a composition for a negative electrode mixture layer. On the other hand, as a binder used for a positive electrode mixture layer, an N-methyl-2-pyrrolidone (NMP) solution of polyvinylidene fluoride (PVDF) is widely used.

In recent years, with the expansion of applications of various secondary batteries, the improvement of energy density, reliability, and durability tends to be required more. For example, more specifications have come to use silicon-based active materials as a negative electrode active material for the purpose of increasing the electric capacity of the lithium ion secondary battery. However, it has been known that the volume change of the silicon-based active material at charging and discharging is large and the electrode mixture layer is separated or falls, for example, due to repeated use, and this results in problems that the battery capacity decreases and the cycle characteristic (durability) deteriorates.

In order to suppress such troubles, examinations have been conducted to improve the durability by firmly binding between the active materials with the binder (bindability), reducing the size of the active material so as to relieve the stress due to swelling expansion and contraction, or devising an additive to an electrolyte solution.

In such circumstances, it has been reported that an acrylic acid-based polymer is effective as a binder having an excellent cycle characteristic and having an effect of improving the durability of a negative electrode mixture layer using a silicon-based active material.

Patent Literature 1 discloses a binder containing a crosslinked acrylic acid-based polymer in which polyacrylic acids are crosslinked with a particular crosslinking agent, and even when an active material containing silicon is used, the excellent cycle characteristic is obtained without damaging an electrode structure. While the binder disclosed in Patent Literature 1 can provide the excellent cycle characteristic, the ratio of the silicon-based active material tends to be increased in order to improve the performance of the secondary battery, and a binder that can obtain a higher cycle characteristic is required.

As a binder for a secondary battery electrode that can improve the cycle characteristic of a secondary battery, for example, Patent Literature 2 discloses a binder for a secondary battery electrode, including a binder containing a copolymer of vinyl alcohol and ethylene unsaturated carboxylic acid alkali metal neutralized substance, and a crosslinking agent having two or more functional groups capable of reacting with a carboxyl group and/or a hydroxyl group in the binder.

Moreover, Patent Literature 3 discloses a binder for a secondary battery electrode, including a polymer having a functional group capable of coupling with a cationic group, and 0.1 parts by mass or more and 8 parts by mass or less of an organic compound (crosslinking agent) having two or more cationic groups and a weight-average molecular weight of 300 or more and less than 10000.

### CITATION LIST

### Patent Literature

Patent Literature 1: WO 2014/065407
Patent Literature 2: WO 2019/054348
Patent Literature 3: WO 2017/150048

### SUMMARY OF INVENTION

### Problems to be Solved by Invention

The binders for a secondary battery electrode disclosed in Patent Literatures 2 and 3 both include a non-crosslinked polymer and by the reaction between the functional group in the polymer and the functional group in the crosslinking agent, the suitable cycle characteristic is obtained but the cycle characteristic may be insufficient. In addition, the toughness of a binder applied film after immersion in an electrolyte solution is not enough and the resistance of a secondary battery electrode composite layer against the electrolyte solution is insufficient, which may result in a problem.

The present invention has been made in view of such a circumstance, and an object is to provide a binder for a secondary battery electrode, by which the toughness of a binder applied film after immersion in an electrolyte solution, the resistance of a secondary battery electrode mixture layer against the electrolyte solution, and the cycle characteristic of a secondary battery can be improved. In addition, the present invention provides a composition for a secondary battery electrode mixture layer including the binder, and a secondary battery electrode and a secondary battery obtained using the composition.

As a result of the present inventors' earnest examination for solving the above problem, it has been found out that by the use of a binder for a secondary battery electrode containing a crosslinked polymer with a structural unit derived from an ethylene unsaturated carboxylic acid monomer or a salt thereof, in which at least a part of the carboxyl group is a functional group used to couple with a cationic group, the toughness of the binder applied film after immersion in the electrolyte solution, the resistance of the secondary battery electrode mixture layer against the electrolyte solution, and the cycle characteristic of the secondary battery can be improved further, and thus, the present invention has been completed.

The present invention is as follows.
[1] A binder for a secondary battery electrode, including a carboxyl group-containing crosslinked polymer or a salt thereof, in which at least a part of the carboxyl group is a functional group used to couple with an organic compound having two or more cationic groups.
[2] The binder for a secondary battery electrode according to [1], further including an organic compound having two or more cationic groups with reactivity to the carboxyl group (this organic compound is hereinafter referred to as “multifunctional cationic group-containing compound”).
[3] The binder for a secondary battery electrode according to [2], in which the multifunctional cationic group-containing compound is contained so that a molar ratio of the cationic group to the carboxyl group in the crosslinked polymer is 0.05 or more and 3.0 or less.
[4] The binder for a secondary battery electrode according to [2] or [3], in which the multifunctional cationic group-containing compound has a molecular weight of 300 or more and 100,000 or less.
[5] The binder for a secondary battery electrode according to any one of [2] to [4], in which the multifunctional cationic group-containing compound includes at least one kind selected from the group consisting of polyethylene imine, a polyethylene imine derivative, and polyether amine.
[6] The binder for a secondary battery electrode according to any one of [1] to [5], in which the carboxyl group-containing crosslinked polymer contains 50 mass % or more and 100 mass % or less of a structural unit derived from an ethylene unsaturated carboxylic acid monomer relative to all structural units of the carboxyl group-containing crosslinked polymer.
[7] The binder for a secondary battery electrode according to any one of [1] to [6], in which the crosslinked polymer is a crosslinked polymer obtained by polymerizing a monomer composition including a non-crosslinkable monomer and a crosslinkable monomer (however, different from the multifunctional cationic group-containing compound).
[8] The binder for a secondary battery electrode according to [7], in which the crosslinkable monomer is used by 0.001 mol % or more and 2.5 mol % or less relative to a total quantity of the non-crosslinkable monomer.
[9] The binder for a secondary battery electrode according to any one of [1] to [8], in which after neutralization to a neutralization degree of 80 to 100 mol %, a particle diameter of the crosslinked polymer that is measured in an aqueous medium is a volume-based median diameter of 0.1 μm or more and 10.0 μm or less.
[10] A composition for a secondary battery electrode mixture layer, including the binder for a secondary battery electrode according to any one of [1] to [9], an active material, and water.
[11] The composition for a secondary battery electrode mixture layer according to [10], in which the active material includes a silicon-based active material.
[12] A secondary battery electrode including a mixture layer formed of the composition for a secondary battery electrode mixture layer according to or on a surface of a current collector.
[13] A secondary battery including the secondary battery electrode according to [12].

### Effects of Invention

By the binder for a secondary battery electrode according to the present invention, the toughness of the binder applied film after the immersion in the electrolyte solution, the resistance of the secondary battery electrode mixture layer against the electrolyte solution, and the cycle characteristic of the secondary battery can be improved.

### DESCRIPTION OF EMBODIMENTS

A binder for a secondary battery electrode according to the present invention (hereinafter also referred to as “the present binder”) includes a carboxyl group-containing crosslinked polymer (hereinafter also referred to as “the present crosslinked polymer”) or a salt thereof (hereinafter also referred to as “the present crosslinked polymer salt”), and a composition for a secondary battery electrode mixture layer (hereinafter also referred to as “the present composition”) can be obtained by mixing an organic compound having two or more cationic groups with reactivity to the carboxyl group (this organic compound is hereinafter also referred to as “multifunctional cationic group-containing compound”), an active material, and water. The aforementioned composition is preferably an electrode slurry in a slurry state that can be applied on a current collector in point of achieving the effect of the present invention; however, the composition can alternatively be prepared as a wet powder state so as to be able to deal with a pressing process on a surface of the current collector. By forming a mixture layer formed of the composition on the surface of the current collector such as a copper foil or an aluminum foil, a secondary battery electrode according to the present invention can be obtained.

Here, the present binder is preferable in that the effect of the present invention is particularly high when the present binder is used for a composition for a secondary battery electrode mixture layer containing a silicon-based active material to be described below as the active material.

Each of the multifunctional cationic group-containing compound, the present crosslinked polymer, a manufacturing method for the same, and the composition for a secondary battery electrode mixture layer, the secondary battery electrode, and the secondary battery that are obtained using the present binder will be described below in detail.

Note that in the present specification, the term “(meth)acrylic” refers to acrylic and/or methacrylic and “(meth)acrylate” refers to acrylate and/or methacrylate. In addition, the term “(meth)acryloyl group” refers to an acryloyl group and/or a methacryloyl group.

In the numeral range described in stages in the present specification, an upper limit value or a lower limit value described in one numeral range may be replaced by an upper limit value or a lower limit value described in stages in another numeral range, and the upper limit value or the lower limit value described in that numeral range may be replaced by a value described in Examples.

### 1. Multifunctional Cationic Group-Containing Compound

A multifunctional cationic group-containing compound is an organic compound having two or more cationic groups, which are functional groups with reactivity to “the carboxyl group included in the present binder”. In the present invention, the cationic group means a functional group existing as a cation in water.

The multifunctional cationic group-containing compound is not limited in particular and may be any organic compound having a plurality of cationic groups in one molecule, the cationic group having reactivity to “the carboxyl group included in the present binder”.

Examples of the cationic group include a nitrogen containing functional group such as substituted or non-substituted amino groups (—NH₂, —NHR₁, —NR₁R₂, and —N⁺R₁R₂R₃, in which R₁ to R₃ represent any substituent), an imino group (═NH), and an oxazoline group (except an amide group), and the like.

Among these examples, from the viewpoints of causing favorable mutual action between the multifunctional cationic group-containing compound and the present crosslinked polymer, securing the viscosity stability of the composition for an electrode composite layer, and further improving the resistance of the electrode composite layer against the electrolyte solution and the cycle characteristic of the secondary battery, a primary amino group (non-substituted amino group, —NH₂), a secondary amino group (—NHR₁), and an imino group are preferable and the primary amino group is more preferable.

Note that the multifunctional cationic group-containing compound may have only one kind of cationic group or two or more kinds of cationic groups. Moreover, the multifunctional cationic group-containing compound may be either a non-polymer or a polymer.

The multifunctional cationic group-containing compound is an organic compound having two or more substituted or non-substituted amino groups (hereinafter also referred to as “amino group-containing compound”) and is classified into an amino group-containing compound, which is a non-polymer, and an amino group-containing compound, which is a polymer.

As the amino group-containing compound, which is the non-polymer, ethylene diamine, 1,4-diaminobutane, triethylene tetramine, phenyl diamine, 4,4′-diamino diphenyl ether, N,N′-bis(3-phenyl-2-propenylidene)-1,6-hexanediamine, bisanilines, and the like are given.

As the amino group-containing compound, which is the polymer, the following are given: polyethylene imine; polyethylene imine derivatives such as polyN-hydroxyl ethylene imine, carboxymethylated polyethylene imine sodium salt; polypropylene imine; polypropylene imine derivatives such as polyN-2-dihydroxylpropylene imine; polyallylamine; polyallylamine derivatives such as polydimethyl diallyl ammonium halide; polyether amines such as polyoxypropylene diamine, triethylene glycol diamine, methoxypoly(oxyethylene/oxypropylene)-2-propylamine, trimethylol propane poly(oxypropylene)triamine, and glycerylpoly(oxypropylene)triamine; aminoethylated acrylic polymer obtained by aminoethylating acrylic acid polymer; cationized cellulose obtained by modifying a cellulose derivative (hydroxyethyl cellulose, carboxymethyl cellulose, or the like) with a cationizing agent having a substituted or non-substituted amino group; and the like.

In particular, in point of being able to further improve the toughness of the binder applied film after the immersion in the electrolyte solution, the resistance of the secondary battery electrode mixture layer against the electrolyte solution, and the cycle characteristic of the secondary battery, polyethylene imine, a polyethylene imine derivative, and polyether amine are preferable, polyethylene imine and polyether amine are more preferable, and polyethylene imine is still more preferable.

In point of being able to further improve the toughness of the binder applied film after the immersion in the electrolyte solution, the resistance of the secondary battery electrode mixture layer against the electrolyte solution, and the cycle characteristic of the secondary battery, here, the molecular weight of the multifunctional cationic group-containing compound is preferably 300 or more and 100,000 or less, more preferably 400 or more and 70,000 or less, still more preferably 600 or more and 50,000 or less, yet still more preferably 2,000 or more and 30,000 or less, much more preferably 5,000 to 20,000, and further preferably 7,000 to 15,000.

In the present invention, in the case where the multifunctional cationic group-containing compound is polyethylene imine and the polyethylene imine derivative, the molecular weight thereof means the number-average molecular weight, and in order to perform the accurate measurement, the measurement is performed by a method of the elevation of boiling point when the number-average molecular weight is 10,000 or less and by viscometry when the number-average molecular weight is over 10,000. In addition, in the case where the multifunctional cationic group-containing compound is polyether amine, the molecular weight thereof means the weight-average molecular weight and can be measured by gel-permeation chromatography (eluent: tetrahydrofuran, reference material: polyethylene glycol, hereinafter referred to as “GPC method”).

### 2. The Present Crosslinked Polymer

The present crosslinked polymer can have a structural unit derived from an ethylene unsaturated carboxylic acid monomer (hereinafter also referred to as “(a) component”) and a monomer component containing the (a) component can be introduced to a polymer by precipitation polymerization or dispersion polymerization.

<Structural Unit Derived from Ethylene Unsaturated Carboxylic Acid Monomer>

The present crosslinked polymer may have the structural unit derived from the ethylene unsaturated carboxylic acid monomer (hereinafter also referred to as “(a) component”). In the case where the present crosslinked polymer has a carboxyl group by having such a structural unit, the adhesion to the current collector is improved and the desolvating effect of lithium ions and the ion conductivity are excellent; thus, the electrode with low resistance and the excellent high-rate characteristic can be obtained. In addition, since a water-swelling property is obtained, the diffusion stability of an active material and the like in the present composition can be increased.

The (a) component can be introduced to the polymer by, for example, polymerization of a monomer including the ethylene unsaturated carboxylic acid monomer. Alternatively, it is obtained by hydrolysis after the (meth)acrylic acid ester monomer is (co-)polymerized. In other methods, after (meth)acrylamide and (meth)acrylonitrile or the like is polymerized, a process with a strong alkali may be performed, or an acid anhydride may be subjected to reaction with a polymer having a hydroxyl group.

Examples of the ethylene unsaturated carboxylic acid monomer include: (meth)acrylic acid, itaconic acid, crotonic acid, maleic acid, and fumaric acid; (meth)acrylamide alkyl carboxylic acids such as (meth)acrylamide hexanoic acid and (meth)acrylamide dodecanoic acid; carboxyl group-containing ethylene unsaturated monomers such as monohydroxyethyl(meth)acrylate succinate, ω-carboxy-caprolactone mono(meth)acrylate, and β-carboxyethyl(meth)acrylate and their (partial) alkali neutralized substance. Any one kind of these compounds may be used alone, or two or more kinds thereof may be used in combination. Among the aforementioned compounds, the compound having an acryloyl group as a polymerizable functional group is preferable and acrylic acid is particularly preferable because a polymer with a long primary chain length is obtained due to its high polymerization speed and the binding strength of the binder is suitable. In the case of using acrylic acid as the ethylene unsaturated carboxylic acid monomer, the polymer with a high content of the carboxyl group can be obtained.

The present crosslinked polymer preferably contains the (a) component by 50 mass % or more and 100 mass % or less relative to the entire structural units of the present crosslinked polymer. By containing the (a) component in such a range, the resistance of the secondary battery electrode mixture layer against the electrolyte solution and the cycle characteristic of the secondary battery can be further improved. It is preferable that the lower limit is 60 mass % or more because the resistance of the secondary battery electrode mixture layer against the electrolyte solution and the cycle characteristic of the secondary battery can be improved more, and for example, the lower limit may be 70 mass % or more, 80 mass % or more, or 87.5 mass % or more. The upper limit is, for example, 99 mass % or less, 98 mass % or less, 95 mass % or less, 90 mass % or less, 85 mass % or less, or 80 mass % or less.

### <Other Structural Unit>

The present crosslinked polymer can include, in addition to the (a) component, a structural unit derived from another ethylene unsaturated monomer capable of copolymerization with these (hereinafter, this structural unit is also referred to as a “(b) component”). As the (b) component, for example, a structural unit derived from a hydroxyl group-containing ethylene unsaturated monomer (monomer expressed by Formula (1) below, monomer expressed by Formula (2) below), an ethylene unsaturated monomer compound having an anionic group other than a carboxyl group such as sulfonic acid group or a phosphoric acid group, a nonionic ethylene unsaturated monomer, or the like is given. These structural units can be introduced by co-polymerizing a hydroxyl group-containing ethylene unsaturated monomer, an ethylene unsaturated monomer compound having an anionic group other than a carboxyl group such as sulfonic acid group or a phosphoric acid group, or a nonionic ethylene unsaturated monomer.

CH₂═C(R¹)COOR² (1)

[In Formula, R¹ represents a hydrogen atom or a methyl group, R² represents a monovalent organic group with 1 to 8 carbon atoms having a hydroxyl group, (R³O)ₘH, or R⁴O[CO(CH₂)ₛO]ₙH. Note that R³ represents an alkylene group with 2 to 4 carbon atoms, R⁴ represents an alkylene group with 1 to 8 carbon atoms, m represents an integer of 2 to 15, and n represents an integer of 1 to 15.]

CH₂═C(R⁵)CONR⁶R⁷ (2)

[In Formula, R⁵ represents a hydrogen atom or a methyl group, R⁶ represents a hydroxyl group or a hydroxyalkyl group with 1 to 8 carbon atoms, and R⁷ represents a hydrogen atom or a monovalent organic group.]

The present crosslinked polymer can contain the (b) component by 0 mass % or more and 50 mass % or less relative to the entire structural units of the present crosslinked polymer. The proportion of the (b) component may be 1 mass % or more and 50 mass % or less, 2 mass % or more and 50 mass % or less, 5 mass % or more and 50 mass % or less, or 10 mass % or more and 50 mass % or less. In the case where the (b) component is contained by 1 mass % or more relative to the entire structural units of the present crosslinked polymer, the affinity to the electrolyte solution is improved, so that the effect of improving the lithium ion conductivity can be expected.

Among the aforementioned examples given as the (b) component, the hydroxyl group-containing ethylene unsaturated monomer is preferable because of being superior in bindability of the binder containing the present crosslinked polymer salt.

From the viewpoint of being able to obtain an electrode with excellent bending resistance, the structural unit derived from the nonionic ethylene unsaturated monomer is preferable.

As the nonionic ethylene unsaturated monomer, (meth)acrylamide and a derivative thereof, a nitrile group-containing ethylene unsaturated monomer, an alicyclic structure containing ethylene unsaturated monomer, or the like is given.

The monomer expressed by Formula (1) above is a (meth)acrylate compound having a hydroxyl group. In the case where R² is a monovalent organic group with 1 to 8 carbon atoms having a hydroxyl group, the number of hydroxyl groups may be either one or two or more. The monovalent organic group is not limited in particular and examples thereof include an alkyl group that may have a straight-chained, branched, or annular structure, an aryl group, an alkoxy alkyl group, and the like. In the case where R² is (R³O)ₘH or R⁴O[CO(CH₂)ₛO]ₙH, the alkylene group expressed by R³ or R⁴ may be in a straight-chained or branched state.

Examples of the monomer expressed by Formula (1) above include hydroxyalkyl(meth)acrylate having a hydroxyalkyl group with 1 to 8 carbon atoms, such as 2-hydroxyethyl(meth)acrylate, 3-hydroxypropyl(meth)acrylate, 4-hydroxybutyl(meth)acrylate, hydroxyhexyl(meth)acrylate, and hydroxyoctyl(meth)acrylate; polyalkylene glycol mono(meth)acrylate such as polyethylene glycol mono(meth)acrylate, polypropylene glycol mono(meth)acrylate, polybutylene glycol mono(meth)acrylate, and polyethylene glycol-polypropylene glycol mono(meth)acrylate; dihydroxyalkyl(meth)acrylate such as glycerin mono(meth)acrylate; and caprolactone-modified hydroxymethacrylate (product name “PLACCEL FM1”, “PLACCEL FM5” or the like manufactured by DAICEL), caprolactone-modified hydroxyacrylate (product name “PLACCEL FA1”, “PLACCEL FA10L” or the like manufactured by DAICEL), and the like. As the monomer expressed by Formula (1) above, any of these may be used alone or two or more kinds of these may be used in combination.

The monomer expressed by Formula (2) above is a (meth)acrylamide derivative having a hydroxyl group or a hydroxyalkyl group with 1 to 8 carbon atoms. In Formula (2), R⁷ represents a hydrogen atom or a monovalent organic group. As the monovalent organic group, for example, an alkyl group that may have a straight-chained, branched, or annular structure, an aryl group, an alkoxy alkyl group, or the like is given without particular limitations, and an organic group with 1 to 8 carbon atoms is preferable. Alternatively, R⁷ may be a hydroxyl group or a hydroxyalkyl group with 1 to 8 carbon atoms.

Examples of the monomer expressed by Formula (2) above include hydroxy (meth)acrylamide; a (meth)acrylamide derivative having a hydroxyalkyl group with 1 to 8 carbon atoms, such as N-hydroxyethyl(meth)acrylamide, N-(2-hydroxypropyl)(meth)acrylamide, N-hydroxybutyl(meth)acrylamide, N-hydroxyhexyl(meth)acrylamide, N-hydroxyoctyl(meth)acrylamide, N-methylhydroxyethyl(meth)acrylamide, and N-ethylhydroxyethyl(meth)acrylamide; N,N-di-hydroxyalkyl(meth)acrylamide such as N,N-dihydroxyethyl(meth)acrylamide and N,N-dihydroxyethyl(meth)acrylamide; and the like. As the monomer expressed by Formula (2) above, any of these may be used alone or two or more kinds thereof may be used in combination.

Examples of the (meth)acrylamide derivative include N-alkyl (meth)acrylamide compounds such as N-isopropyl (meth)acrylamide and N-t-butyl(meth)acrylamide; N-alkoxyalkyl (meth)acrylamide compounds such as N-n-butoxymethyl(meth)acrylamide and N-isobutoxymethyl(meth)acrylamide; and N,N-dialkyl (meth)acrylamide compounds such as N,N-dimethyl(meth)acrylamide and N,N-diethyl(meth)acrylamide. Any of these may be used alone or two or more kinds may be used in combination.

Examples of the nitrile group-containing ethylene unsaturated monomer include (meth)acrylonitrile; (meth)acrylic acid cyanoalkylester compounds such as (meth)acrylic acid cyanomethyl and (meth)acrylic acid cyanoethyl; cyano group-containing unsaturated aromatic compounds such as 4-cyanostyrene and 4-cyano-«-methylstyrene; vinylidene cyanide; and the like. Any of these may be used alone or two or more kinds may be used in combination. In particular, acrylonitrile is preferable because the nitrile group is contained more.

Examples of the alicyclic structure containing ethylene unsaturated monomer include (meth)acrylic acid cycloalkylester that may have an aliphatic substituent, such as cyclopentyl(meth)acrylate, cyclohexyl(meth)acrylate, methylcyclohexyl(meth)acrylate, t-butylcyclohexyl(meth)acrylate, cyclodecyl(meth)acrylate, and cyclododecyl(meth)acrylate; cycloalkylpolyalcoholmono(meth)acrylate such as isobornyl(meth)acrylate, adamantyl(meth)acrylate, cyclopentenyl(meth)acrylate, dicyclopentenyloxyethyl(meth)acrylate, dicyclopentanyl(meth)acrylate, cyclohexanedimethanolmono(meth)acrylate, and cyclodecanedimethanolmono(meth)acrylate; and the like. Any of these may be used alone or two or more kinds may be used in combination.

The present crosslinked polymer preferably includes the structural unit derived from the monomer expressed by Formula (1) above, the monomer expressed by Formula (2) above, (meth)acrylamide and its derivative, the nitrile group-containing ethylene unsaturated monomer, the alicyclic structure containing ethylene unsaturated monomer, or the like because the bindability of the binder is excellent. In particular, the structural units derived from the monomer expressed by Formula (1) above and the monomer expressed by Formula (2) above are more preferable as the (b) component because the effect of improving the bindability of the present binder is superior.

Among the monomers expressed by Formula (1) above, hydroxyalkyl(meth)acrylate having a hydroxyalkyl group with 1 to 8 carbon atoms is more preferable and 2-hydroxyethyl(meth)acrylate, 3-hydroxypropyl(meth)acrylate, and 4-hydroxybutyl(meth)acrylate is still more preferable. Among the monomers expressed by Formula (2) above, a (meth)acrylamide derivative having a hydroxyalkyl group with 1 to 8 carbon atoms is more preferable and N-hydroxyethyl(meth)acrylamide, N-(2-hydroxypropyl)(meth)acrylamide, and N-hydroxybutyl(meth)acrylamide is still more preferable.

In the case where the structural unit derived from a hydrophobic ethylene unsaturated monomer with a solubility in water of 1 g/100 ml or less as the (b) component, the strong mutual operation with the electrode material can be obtained and the excellent bindability with respect to the active material can be achieved. Accordingly, the tough electrode mixture layer with the suitable integrity can be obtained, and for this reason, the alicyclic structure containing ethylene unsaturated monomer is particularly preferable as the “hydrophobic ethylene unsaturated monomer with a solubility in water of 1 g/100 ml or less” described above.

As another nonionic ethylene unsaturated monomer, for example, (meth)acrylic acid ester may be used. Examples of the (meth)acrylic acid ester include (meth)acrylic acid alkyl ester compounds such as methyl(meth)acrylate, ethyl(meth)acrylate, n-butyl(meth)acrylate, isobutyl(meth)acrylate, and 2-ethylhexyl(meth)acrylate; aromatic (meth)acrylic acid ester compounds such as phenyl(meth)acrylate, phenylmethyl(meth)acrylate, phenylethyl(meth)acrylate, and phenoxyethyl(meth)acrylate; (meth)acrylic acid alkoxyalkylester compounds such as 2-methoxyethyl(meth)acrylate and 2-ethoxyethyl(meth)acrylate; and the like. Any of these may be used alone or two or more kinds may be used in combination.

From the viewpoint of the bindability with the active material and the cycle characteristic, the aromatic (meth)acrylic acid ester compound is preferably used. From the viewpoint of further improving the lithium ion conductivity and the high rate characteristic, a compound with an ether bond, for example, (meth)acrylic acid alkoxyalkylester such as 2-methoxyethyl(meth)acrylate and 2-ethoxyethyl(meth)acrylate is preferable and 2-methoxyethyl(meth)acrylate is more preferable.

Among the nonionic ethylene unsaturated monomers, a compound with an acryloyl group is preferable because a polymer with a long primary chain length is obtained due to its high polymerization speed and the binding strength of the binder is favorable. As the nonionic ethylene unsaturated monomer, a compound in which the glass transition temperature (Tg) of a homopolymer is 0° C. or less is preferable because the bending resistance of the electrode to be obtained is favorable.

The present crosslinked polymer is a crosslinked polymer with a crosslinking structure. A crosslinking method for the present crosslinked polymer is not limited in particular and for example, aspects by the following methods are given.
1) Copolymerization of crosslinkable monomers (however, different from the multifunctional cationic group-containing compound)
2) Use of chain transfer to a polymer chain at radical polymerization

Since the present crosslinked polymer has the crosslinked structure, the binder with the crosslinked polymer or its salt can have the excellent binding strength. Among the above methods, the method by the copolymerization of the crosslinkable monomers is preferable because the operation is easy and the degree of crosslinking is easily controllable.

### <Crosslinkable Monomer>

As the crosslinkable monomer, a multifunctional polymerizable monomer having two or more polymerizable unsaturated groups, a monomer with a crosslinkable functional group capable of self-crosslinking, such as a hydrolyzable silyl group, or the like is given. However, the crosslinkable monomer is different from the multifunctional cationic group-containing compound.

The multifunctional polymerizable monomer is a compound having two or more polymerizable functional groups such as a (meth)acryloyl group or an alkenyl group in a molecule, and a multifunctional (meth)acryloyl compound, a multifunctional alkenyl compound, a compound having both a (meth)acryloyl group and an alkenyl group, or the like is given. Only one kind of these compounds may be used alone or two or more kinds may be used in combination. Among these, the multifunctional alkenyl compound is preferable because the uniform crosslinked structure is obtained easily and a multifunctional allyl ether compound having two or more allyl ether groups in a molecule is particularly preferable.

Examples of the multifunctional (meth)acryloyl compound include di(meth)acrylates of divalent alcohol, such as ethylene glycol di(meth)acrylate, propylene glycol di(meth)acrylate, 1,6-hexanediol di(meth)acrylate, polyethylene glycol di(meth)acrylate, and polypropylene glycol di(meth)acrylate; tri(meth)acrylates of tri- or more-valent alcohol, such as trimethylol propane tri(meth)acrylate, tri(meth)acrylate of a trimethylol propane ethylene oxide modified body, glycerin tri(meth)acrylate, pentaerythritol tri(meth)acrylate, and pentaerythritol tetra(meth)acrylate, tetra(meth)acrylate, and other poly(meth)acrylates; polyfunctional urethane(meth)acrylate such as bifunctional urethane(meth)acrylate; bisamides such as methylene bisacrylamide and hydroxyethylene bisacrylamide; and the like.

Examples of the multifunctional alkenyl compound include multifunctional allyl ether compounds such as trimethylol propane diallyl ether, trimethylol propane triallyl ether, pentaerythritol diallyl ether, pentaerythritol triallyl ether, tetraallyl oxyethane, and polyallyl saccharose; multifunctional allyl compounds such as diallyl phthalate; multifunctional vinyl compounds such as divinyl benzene; and the like.

Examples of the compound having both a (meth)acryloyl group and an alkenyl group include (meth)acrylic acid allyl, (meth)acrylic acid isopropenyl, (meth)acrylic acid butenyl, (meth)acrylic acid pentenyl, (meth)acrylic acid 2-(2-vinyloxyethoxy)ethyl, and the like.

Specific examples of the monomer with a crosslinkable functional group capable of self-crosslinking include a hydrolyzable silyl group-containing vinyl monomer, N-methoxyalkyl(meth)acrylamide, and the like. One kind of these compounds can be used alone or two or more kinds thereof can be used in combination.

The hydrolyzable silyl group-containing vinyl monomer is not limited in particular and may be any vinyl monomer having at least one hydrolyzable silyl group. Examples thereof include vinyl silanes such as vinyl trimethoxy silane, vinyl triethoxy silane, vinyl methyl dimethoxy silane, and vinyl dimethyl methoxy silane; silyl group-containing acrylic acid esters such as acrylic acid trimethoxy silyl propyl, acrylic acid triethoxy silyl propyl, and acrylic acid methyl dimethoxy silyl propyl; silyl group-containing methacrylic acid esters such as methacrylic acid trimethoxy silyl propyl, methacrylic acid triethoxy silyl propyl, methacrylic acid methyl dimethoxy silyl propyl, and methacrylic acid dimethyl methoxy silyl propyl; silyl group-containing vinyl ethers such as trimethoxy silyl propyl vinyl ether; silyl group-containing vinyl esters such as trimethoxy silyl undecanoic acid vinyl; and the like.

In the case where the present crosslinked polymer is crosslinked by the crosslinkable monomers, the crosslinkable monomers are used by preferably 0.01 parts by mass or more and 5.0 parts by mass or less, more preferably 0.05 parts by mass or more and 3.0 parts by mass or less, still more preferably 0.1 parts by mass or more and 2.0 parts by mass or less, much more preferably 0.1 parts by mass or more and 1.7 parts by mass or less, and far more preferably 0.5 parts by mass or more and 1.5 parts by mass or less relative to a total of 100 parts by mass of the monomers other than the crosslinkable monomers (non-crosslinkable monomers). The crosslinkable monomers are used by preferably 0.01 parts by mass or more because the bindability and the precipitation stability of the electrode slurry will become more suitable. When the crosslinkable monomers are used by 5.0 parts by mass or less, the precipitation polymerization or dispersion polymerization tends to become more stable.

Because of the similar reason, the crosslinkable monomers are used by preferably 0.001 mol % or more and 2.5 mol % or less, more preferably 0.01 mol % or more and 2.0 mol % or less, still more preferably 0.05 mol % or more and 1.75 mol % or less, much more preferably 0.05 mol % or more and 1.5 mol % or less, and far more preferably 0.1 mol % or more and 1.0 mol % or less relative to the total amount of monomers other than the crosslinkable monomers (non-crosslinkable monomers).

The present crosslinked polymer salt is in a mode of a salt in which a part or all of carboxyl groups included in the polymer are neutralized. The kind of salt is not limited in particular and examples thereof include: alkali metal salts such as lithium salt, sodium salt, and potassium salt; alkaline earth metal salts such as magnesium salt, calcium salt, and barium salt; other metal salts such as aluminum salt; ammonium salt and organic amine salts; and the like. Among these salts, alkali metal salts and alkaline earth metal salts are preferable and alkali metal salts are more preferable because an adverse effect is not easily caused on the battery characteristics.

### Characteristic of the Present Crosslinked Polymer Salt

The present crosslinked polymer is preferably used as a mode of salt in which, in the present composition, an acid group such as a carboxyl group derived from the ethylene unsaturated carboxylic acid monomer is neutralized so that the neutralization degree becomes 20 mol % or more. The neutralization degree is more preferably 50 mol % or more, still more preferably 70 mol % or more, much more preferably 75 mol % or more, far more preferably 80 mol % or more, and particularly preferably 85 mol % or more. The upper limit value of the neutralization degree is 100 mol %, and may be 98 mol % or 95 mol %. The neutralization degree is preferably 20 mol % or more because the water swelling property becomes suitable and the effect of stabilizing the dispersion can be obtained easily. In the present specification, the neutralization degree can be calculated by calculation from preparation values of the monomers having an acid group such as a carboxyl group and a neutralizer used for the neutralization. Note that the neutralization degree can be checked by measuring the IR of powder of the crosslinked polymer salt after performing a drying process at 80° C. for three hours under a reduced-pressure condition and using the intensity ratio between the peak derived from a C═O group of the carboxylic acid and the peak derived from a C═O group of the carboxylic acid salt.

### <Particle Diameter of the Present Crosslinked Polymer Salt>

In the present composition, it is preferable that the present crosslinked polymer salt does not exist as an aggregate of large-diameter particles (secondary aggregate) and is diffused suitably as water-swelling particles with a suitable particle diameter because the binder containing such a crosslinked polymer salt can exhibit the suitable binding performance.

It is preferable that the particle diameter (water-swelling particle diameter) when the present crosslinked polymer with a neutralization degree of 80 to 100 mol % based on the carboxyl group in the crosslinked polymer is diffused in water is in the range of 0.1 μm or more and 10.0 μm or less in terms of volume-based median diameter. The particle diameter is in the range of preferably 0.15 μm or more and 8.0 μm or less, more preferably 0.20 μm or more and 6.0 μm or less, still more preferably 0.25 μm or more and 4.0 μm or less, and even more preferably 0.30 μm or more and 2.0 μm or less. When the particle diameter is in the range of 0.30 μm or more and 2.0 μm or less, the present crosslinked polymer exists uniformly in a suitable size in the present composition; therefore, the present composition has high stability and can therefore exhibit the excellent bindability. When the particle diameter is over 10.0 μm, the bindability may become insufficient as described above. In addition, the coating property may be become insufficient because it is difficult to obtain a flat coating surface. On the other hand, when the particle diameter is less than 0.1 μm, there is a concern from the viewpoint of stable manufacturing.

### <Viscosity of Aqueous Solution of the Present Crosslinked Polymer Salt>

The viscosity of an aqueous solution containing 2 mass % of the present crosslinked polymer salt is preferably 100 mPa's or more. In the case where the viscosity of the aqueous solution with a concentration of 2 mass % is 100 mPa's or more, the preservation stability of the composition containing the crosslinked polymer is high and the excellent bindability can be exhibited. The viscosity of the 2-mass % aqueous solution may be 1,000 mPa's or more, 10,000 mPa's or more, or 50,000 mPa·s or more.

The viscosity of the aqueous solution is obtained by dissolving or diffusing the present crosslinked polymer salt in a quantity to obtain a predetermined concentration uniformly in water and then measuring the B-type viscosity (25° C.) at 12 rpm in accordance with a method described in Example below.

In water, the present crosslinked polymer salt absorbs water and swells. In general, in the case where the crosslinked polymer has a suitable crosslinking degree, the crosslinked polymer containing more hydrophilic groups absorbs water more and swells more easily. Regarding the crosslinking degree, as the crosslinking degree is lower, the crosslinked polymer swells more easily. However, even if the number of crosslinking points is the same, more crosslinking points contribute to the formation of a three-dimensional network as the molecular weight (primary chain length) is larger, in which case it is difficult for the crosslinked polymer to swell. Accordingly, the viscosity of the crosslinked polymer aqueous solution can be adjusted by adjusting the amount of hydrophilic groups of the crosslinked polymer, the number of crosslinking points, the primary chain length, and the like. In this case, the number of crosslinking points can be adjusted by, for example, the use amount of the crosslinkable monomers, the chain transfer reaction to the polymer chain, the post-crosslinking reaction, or the like. In addition, the primary chain length of the polymer can be adjusted by setting the conditions related to the radical generation quantity, such as an initiator and polymerization temperature, and selecting the polymerization solvent considering the chain transfer or the like, for example.

### <Water Swelling Degree of the Present Crosslinked Polymer Salt>

In the present specification, the water swelling degree is calculated based on the following expression using the weight “(WA) g” when the crosslinked polymer salt is dry and the amount of water “(WB) g” absorbed when the crosslinked polymer salt is saturated and swelled with water.

$$( Water swelling degree ) = \{ ( {W}_{A} ) + ( {W}_{B} ) \} / ( {W}_{A} )$$

The crosslinked polymer salt preferably has a water swelling degree of 20 or more and 80 or less at a pH of 8. When the water swelling degree is in this range, the crosslinked polymer salt swells suitably in an aqueous medium; therefore, when the electrode mixture layer is formed, the sufficient adhesion area for the active material and the current collector can be secured and the bindability tends to be suitable. The water swelling degree may be, for example, 21 or more, 23 or more, 25 or more, 27 or more, or 30 or more. In the case where the water swelling degree is 20 or more, the crosslinked polymer salt spreads on the surface of the active material or the current collector so as to secure the sufficient adhesion area; thus, the suitable bindability is obtained. The upper limit value of the water swelling degree at a pH of 8 may be 75 or less, 70 or less, 65 or less, 60 or less, or 55 or less. When the water swelling degree is over 60, the viscosity of the composition for an electrode mixture layer (electrode slurry) containing the crosslinked polymer salt tends to become higher and the uniformity of the mixture layer becomes insufficient, in which case it may be impossible to obtain the sufficient binding strength. In addition, the coating property of the electrode slurry may decrease.

The water swelling degree at a pH of 8 can be obtained by measuring the swelling degree of the crosslinked polymer salt in water with a pH of 8. As the water with a pH of 8, for example, ion exchange water can be used and as necessary, the pH value may be adjusted using a suitable acid or alkali, or a buffer solution or the like. The pH at the measurement is, for example, in the range of 8.0±0.5, preferably in the range of 8.0±0.3, more preferably in the range of 8.0±0.2, and still more preferably in the range of 8.0±0.1. The measurement is performed at 25±5° C.

Note that a person who is skilled in the art can adjust the water swelling degree by controlling the composition, the structure, and the like of the crosslinked polymer salt. For example, the water swelling degree can be increased by introducing an acid functional group or a structural unit with high hydrophilicity to the crosslinked polymer. In addition, the water swelling degree usually becomes high also by reducing the crosslinking degree of the crosslinked polymer.

### 3. Manufacturing Method for the Present Crosslinked Polymer

The present crosslinked polymer can use a known polymerization method such as solution polymerization, precipitation polymerization, suspension polymerization, or emulsion polymerization, and in point of the productivity, precipitation polymerization and suspension polymerization (reversed-phase suspension polymerization) are preferable. In point of being able to obtain more suitable performance regarding the bindability or the like, the non-uniform polymerization method such as precipitation polymerization, suspension polymerization, or emulsion polymerization is preferable and among these, a precipitation polymerization method is more preferable.

The precipitation polymerization is a method of manufacturing a polymer by performing the polymerization reaction in a solvent that dissolves the unsaturated monomer, which is the raw material, but substantially does not dissolve the generated polymer. As the polymerization progresses, the polymer particles aggregate and grow bigger, so that a dispersion liquid of polymer particles, in which primary particles of several tens of nanometers to several hundreds of nanometers are aggregated secondarily into several micrometers to several tens of micrometers, is obtained. A dispersion stabilizer can also be used to control the particle size of the polymer.

Note that the secondary aggregation can be suppressed by selecting the dispersion stabilizer, a polymerization solvent, or the like. In general, the precipitation polymerization in which the secondary aggregation is suppressed is also called dispersion polymerization.

In the case of the precipitation polymerization, a solvent selected from water, various organic solvents, and the like can be used as the polymerization solvent in consideration of the kind of monomers to be used, for example. In order to obtain the polymer with a longer primary chain length, it is preferable to use a solvent with a small chain transfer constant.

Specific polymerization solvents include water-soluble solvents such as methanol, t-butyl alcohol, acetone, methyl ethyl ketone, acetonitrile, and tetrahydrofuran, and moreover, benzene, ethyl acetate, dichloroethane, n-hexane, cyclohexane, n-heptane, and the like. One kind of these can be used alone or two or more kinds thereof can be used in combination. Alternatively, a mixed solvent containing any of these and water may be used. In the present invention, the water-soluble solvent refers to a solvent whose solubility in water at 20° C. is more than 10 g/100 ml.

Among those described above, methyl ethyl ketone and acetonitrile are preferable because the generation of coarse particles and the adhesion to a reactor are suppressed and the polymerization stability is favorable, the precipitated polymer microparticles are not easily aggregated secondarily (or even if the secondary aggregation occurs, the aggregate is easily disassembled in the aqueous medium), the chain transfer constant is small and the polymer with a high polymerization degree (primary chain length) is obtained, and the operation is easy in a process of neutralization to be described below, for example.

As a polymerization initiator, a known polymerization initiator such as an azo-based compound, an organic peroxide, or an inorganic peroxide can be used without particular limitations. The use condition can be adjusted so that a suitable amount of radicals is generated by a known method such as redox initiation using a thermal initiator and a reducing agent in combination, or UV initiation. In order to obtain the crosslinked polymer with the long primary chain length, it is preferable to set the condition so that the amount of generated radicals becomes smaller in the range where the manufacturing time is allowed.

The polymerization initiator is used by, for example, preferably 0.001 to 2 parts by mass, 0.005 to 1 part by mass, or 0.01 to 0.1 parts by mass when the total amount of monomer components used is 100 parts by mass. When the polymerization initiator is used by 0.001 parts by mass or more, the polymerization reaction can be performed stably and when the polymerization initiator is used by 2 parts by mass or less, the polymer with the long primary chain length is obtained easily.

The polymerization temperature is preferably 0 to 100° C. and more preferably 20 to 80° C., although depending on the kind and concentration of the monomer to be used, for example. The polymerization temperature may be either constant or variable in a period of the polymerization reaction. In addition, the polymerization time is preferably 1 minute to 20 hours, and more preferably 1 hour to 10 hours.

Here, the present crosslinked polymer can contain 50 mass % or more and 100 mass % or less of the ethylene unsaturated carboxylic acid monomer. The kind of ethylene unsaturated carboxylic acid monomer is as described above.

### 4. Composition for Secondary Battery Electrode Mixture Layer

The composition for a secondary battery electrode mixture layer according to the present invention includes the present binder, the multifunctional cationic group-containing compound, the active material, and water.

The present binder is used in the present composition by, for example, 0.1 parts by mass or more and 20 parts by mass or less relative to a total of 100 parts by mass of the active material. In other examples, the present binder is used by 0.2 parts by mass or more and 10 parts by mass or less, 0.3 parts by mass or more and 8 parts by mass or less, or 0.4 parts by mass or more and 5 parts by mass or less. When the binder is used by 0.1 parts by mass or more, the sufficient bindability can be obtained. In addition, the dispersion stability of the active material and the like can be secured and the uniform mixture layer can be formed. When the binder is used by 20 parts by mass or less, the present composition will not have high viscosity and the coating property on the current collector can be secured. As a result, the mixture layer with a uniform and flat surface can be formed.

The multifunctional cationic group-containing compound is used in the present composition by, for example, 0.1 parts by mass or more and 20 parts by mass or less relative to a total of 100 parts by mass of the present binder. In other examples, the multifunctional cationic group-containing compound is used by 0.5 parts by mass or more and 15 parts by mass or less, 1.0 parts by mass or more and 10 parts by mass or less, or 2.0 parts by mass or more and 8 parts by mass or less. In particular, when the multifunctional cationic group-containing compound is used by 0.1 parts by mass or more, the crosslinking structure between the present crosslinked polymers is formed sufficiently by the reaction between the multifunctional cationic group-containing compound and the carboxyl group in the present crosslinked polymer, and the toughness of the binder applied film after the immersion in the electrolyte solution, the resistance of the secondary battery electrode mixture layer against the electrolyte solution, and the cycle characteristic of the secondary battery can be improved. When the multifunctional cationic group-containing compound is used by 20 parts by mass or less, the amount of the unreacted multifunctional cationic group-containing compound is reduced and the toughness of the binder applied film after the immersion in the electrolyte solution, the resistance of the secondary battery electrode mixture layer against the electrolyte solution, and the cycle characteristic of the secondary battery can be improved.

In point of being able to achieve the toughness of the binder applied film after the immersion in the electrolyte solution, the resistance of the secondary battery electrode mixture layer against the electrolyte solution, and the cycle characteristic of the secondary battery, as the amount of the multifunctional cationic group-containing compound to be used, the molar ratio of the cationic group to the carboxyl group in the present binder is preferably 0.05 mol or more and 3.0 mol or less, more preferably 0.1 mol or more and 2.5 mol or less, still more preferably 0.2 mol or more and 2.0 mol or less, yet still more preferably 0.3 mol or more and 1.5 mol or less, even more preferably 0.5 mol or more and 1.3 mol or less, and far more preferably 0.7 mol or more and 1.0 mol or less.

In the active material, the positive electrode active material can employ a lithium salt of transition metal oxide and for example, a layered rock salt type or spinel type lithium-containing metal oxide can be used. Specific compounds of the layered rock salt type positive electrode active material include lithium cobaltate, lithium nickelate, and NCM {Li(Niₓ, Co_{y}, Mn_{z}), x+y+z=1} and NCA {Li(Ni_{1-a-b}CO₂Al_{b})}, which are called ternary materials, and the like. In addition, as the spinel type positive electrode active material, lithium manganate and the like are given. In addition to oxides, phosphate, silicate, sulfur, and the like are usable and as the phosphate, olivin type lithium iron phosphate and the like are given. As the positive electrode active material, one kind of the aforementioned materials may be used alone or two or more kinds thereof may be used in combination as a mixture or a composite.

Note that in the case where the positive electrode active material including the layered rock salt type lithium-containing metal oxide is diffused in water, lithium ions on the surface of the active material and hydrogen ions in water are exchanged so that the dispersion liquid exhibits an alkaline property. This may result in a risk that an aluminum foil (Al) or the like, which is a general current collector material for a positive electrode, is corroded. In such a case, it is preferable to neutralize the alkali component eluted from the active material by the use of the present crosslinked polymer that is not neutralized or is partially neutralized as the binder. The amount of the present crosslinked polymer to be used that is not neutralized or is partially neutralized is preferably determined so that the amount of the carboxyl group in the crosslinked polymer that is not neutralized is more than or equal to the equivalent to the amount of alkali that is eluted from the active material.

Since any positive electrode active material is low in electric conductivity, the positive electrode active material is usually used with a conductive auxiliary agent added thereto. As the conductive auxiliary agent, carbon-based materials such as carbon black, carbon nanotube, carbon fiber, graphite micropowder, and carbon fiber are given. Among these materials, carbon black, carbon nanotube, and carbon fiber are preferable because the excellent conductivity is obtained easily. As the carbon black, Ketjen black and acetylene black are preferable. One kind of the aforementioned conductive auxiliary agents may be used alone or two or more kinds thereof may be used in combination. The conductive auxiliary agent is used by, for example, 0.2 to 20 parts by mass or 0.2 to 10 parts by mass relative to a total of 100 parts by mass of the active material from the viewpoint of achieving both the conductivity and the energy density. Alternatively, the positive electrode active material with a surface coated with a carbon material with conductivity may be used.

On the other hand, for example, carbon-based materials, lithium metals, lithium alloys, metal oxides, and the like are given, and one kind of these or a combination of two or more kinds thereof may be used. Among these, an active material formed of a carbon-based material such as natural graphite, synthetic graphite, hard carbon, or soft carbon (hereinafter also referred to as “carbon-based active material”) is preferable, and graphite such as natural graphite or synthetic graphite and hard carbon are more preferable. In the case of graphite, spherical graphite is suitably used from the perspective of battery performance, and the preferable range of the particle size thereof is, for example, 1 to 20 μm or 5 to 15 μm. In addition, in order to increase the energy density, metal that can store lithium, such as silicon or tin, metal oxide, or the like can also be used as the negative electrode active material. Among these, silicon has higher capacity than graphite and an active material formed of a silicon-based material (hereinafter also referred to as “silicon-based active material”), for example silicon, silicon alloy, or silicon oxide such as silicon monoxide (SiO) can be used. However, while the silicon-based active material has high capacity, the volume change due to charging and discharging is large. Therefore, it is preferable to use the silicon-based active material in combination with the carbon-based active material described above. In this case, if the silicon-based active material is mixed in a large quantity, the electrode material may collapse and the cycle characteristic (durability) may largely deteriorate. From such a perspective, in the case of using the silicon-based active material in combination, the silicon-based active material is used by, for example, 60 mass % or less or 30 mass % or less relative to the carbon-based active material.

Since the carbon-based active material itself has the excellent electric conductivity, it is not always necessary to add the conductive auxiliary agent. In the case of adding the conductive auxiliary agent for the purpose of reducing the resistance further, for example, the conductive auxiliary agent is used by, for example, 10 parts by mass or less or 5 parts by mass or less relative to a total of 100 parts by mass of the active material from the viewpoint of the energy density.

In the case where the present composition is in a slurry state, the active material is used by, for example, 10 to 75 mass % or 30 to 65 mass % relative to the entire amount of the present composition. When the active material is used by 10 mass % or more, the migration of the binder or the like can be suppressed and this is advantageous in point of the cost in drying the medium. On the other hand, when the active material is used by 75 mass % or less, the fluidity and coating property of the present composition can be secured and the uniform mixture layer can be formed.

The present composition uses water as a medium. For the purpose of adjusting the property, drying performance, and the like of the present composition, a mixed solvent may be formed with lower alcohols such as methanol or ethanol, carbonates such as ethylene carbonate, ketones such as acetone, or a water-soluble organic solvent such as tetrahydrofuran or N-methyl-2-pyrrolidone. The proportion of water in the mixed solvent is, for example, 50 mass % or more or 70 mass % or more.

In the case of making the present composition into the slurry state capable of coating, the content of the medium containing water in the entire present composition can be, for example, 25 to 60 mass % or 35 to 60 mass % from the viewpoints of the slurry coatability, the energy cost necessary for drying, and the productivity.

The present composition may additionally use another binder component such as styrene butadiene rubber (SBR) latex, carboxy methyl cellulose (CMC), acrylic latex, or polyvinylidene fluoride latex in combination. In the case of using another binder component in combination, the use amount thereof can be, for example, 0.1 to 5 parts by mass or less, 0.1 to 2 parts by mass or less, 0.1 or to 1 part by mass or less relative to a total of 100 parts by mass of the active material. When another binder component is used by more than 5 parts by mass, the resistance may increase to make the high-rate characteristic insufficient. Among those mentioned above, SBR latex and CMC are preferable and using SBR latex and CMC in combination is more preferable because of being superior in balance between the bindability and the bending resistance.

The SBR latex refers to an aqueous dispersion element of a copolymer with a structural unit derived from an aromatic vinyl monomer such as styrene and a structural unit derived from an aliphatic conjugated diene monomer such as 1,3-butadiene. As the aromatic vinyl monomer, «-methyl styrene, vinyl toluene, divinyl benzene, and the like are given in addition to styrene and one kind of these or two or more kinds thereof can be used. From the viewpoint of the bindability mainly, the structural unit derived from the aromatic vinyl monomer in the copolymer can be, for example, in the range of 20 to 70 mass % or in the range of 30 to 60 mass %.

Examples of the aliphatic conjugated diene monomer include, in addition to 1,3-butadiene, 2-methyl-1,3-butadiene, 2,3-dimethyl-1,3-butadiene, 2-chloro-1,3-butadiene, and the like, and one kind of these or two or more kinds thereof can be used. The structural unit derived from the aliphatic conjugated diene monomer in the copolymer can be, for example, in the range of 30 to 70 mass % or in the range of 40 to 60 mass % because the bindability of the binder and the flexibility of the electrode to be obtained become excellent.

As the styrene/butadiene latex, in addition to the aforementioned monomer, a nitrile group-containing monomer such as (meth)acrylonitrile, a carboxyl group-containing monomer such as (meth)acrylic acid, itaconic acid, or maleic acid, or an ester group-containing monomer such as (meth)acrylic acid methyl may be used as the copolymer monomer in order to improve the bindability and the like further.

The structural unit derived from the other monomer in the copolymer can be, for example, in the range of 0 to 30 mass % or in the range of 0 to 20 mass %.

The CMC represents a substituted body in which a nonionic cellulose semi-synthetic polymer compound is substituted with a carboxyl methyl group, or a salt of the substituted body. Examples of the nonionic cellulose semi-synthetic polymer compound include: alkyl cellulose such as methyl cellulose, methyl ethyl cellulose, ethyl cellulose, and microcrystalline cellulose; and hydroxyalkyl cellulose such as hydroxyethyl cellulose, hydroxybutyl methyl cellulose, hydroxypropyl cellulose, hydroxypropyl methyl cellulose hydroxyethyl methyl cellulose, hydroxypropyl methyl cellulose stearoxy ether, carboxymethyl hydroxyethyl cellulose, alkyl hydroxyethyl cellulose, and nonoxynyl hydroxyethyl cellulose; and the like.

The composition for a secondary battery electrode mixture layer according to the present invention includes the aforementioned binder, the multifunctional cationic group-containing compound, the active material, and water as the necessary components, and is obtained by mixing the respective components using a known method. The components may be mixed by any method without particular limitations and known methods can be employed. It is preferable to use a method in which powder components of the active material, the conductive auxiliary agent, the binder, and the like are blended in a dry procedure, mixed with a dispersion medium such as water, and then diffused and kneaded. In the case of obtaining the present composition in a slurry state, it is preferable to finish the composition in a slurry without causing diffusion failure or aggregation. The mixing method may use a known mixer such as a planetary mixer, a thin-film spin system mixer, or a rotating and revolving mixer. It is preferable to use a thin-film spin system mixer because the favorable diffusion state can be obtained in a short time. In the case of using a thin-film spin system mixer, it is preferable to perform the preliminary diffusion with a stirrer such as a disperser in advance. The pH of the slurry is not limited in particular as long as the effect of the present invention is obtained: however, the pH thereof is preferably less than 12.5 and for example, when CMC is mixed, the pH is more preferably less than 11.5 and still more preferably less than 10.5 in order to lower the risk of the hydrolysis. The viscosity of the slurry is not limited in particular as long as the effect of the present invention is obtained; however, the viscosity thereof can be set, for example, in the range of 100 to 6,000 mPa·s, 500 to 5,000 mPa·s, or 1,000 to 4,000 mPa's as the B-type viscosity (25° C.) at 20 rpm. When the slurry has the viscosity in the aforementioned range, the suitable coating property can be secured.

### 5. Secondary Battery Electrode

The secondary battery electrode according to the present invention includes the mixture layer, which is formed of the composition for a secondary battery electrode mixture layer according to the present invention, on the surface of the current collector of copper, aluminum, or the like. The mixture layer is formed by coating the surface of the current collector with the present composition and then drying and removing the medium such as water. The coating with the present composition may employ any method without particular limitations and a known method such as a doctor blade method, a dip method, a roll coating method, a comma coating method, a curtain coating method, a gravure coating method, or an extrusion method can be employed. The drying can be performed by a known method such as warm air blowing, reduced pressure, (far)-infrared rays, or microwave irradiation.

The mixture layer obtained after the drying is generally subjected to a compression process by mold pressing, roll pressing, or the like. The compression can bring the active material and the binder in close contact with each other, thereby improving the strength of the mixture layer and the adhesion to the current collector. By the compression, the thickness of the mixture layer can be adjusted to about 30 to 80% of the thickness before the compression, for example, and the thickness of the compressed mixture layer is usually about 4 to 200 μm.

### 6. Secondary Battery

Providing a separator and an electrolyte solution in the secondary battery electrode according to the present invention can manufacture a secondary battery. The electrolyte solution may be either liquid or gel.

The separator is disposed between the positive electrode and the negative electrode of the battery and plays the roles of preventing the short-circuit due to their contact and securing the ion conductivity by keeping the electrolyte solution. The separator is preferably a film-shaped insulating microporous film with suitable ion permeability and mechanical strength. As a specific material, polyolefin such as polyethylene or polypropylene, polytetrafluoroethylene, or the like can be used.

As the electrolyte solution, a known electrolyte solution that is generally employed can be used in accordance with the kind of active material. As a specific solvent in the lithium ion secondary battery, cyclic carbonates with a high dielectric constant and a high capability of dissolving the electrolyte, such as propylene carbonate and ethylene carbonate, chain carbonates with low viscosity, such as ethyl methyl carbonate, dimethyl carbonate, and diethyl carbonate, and the like are given, and any of these can be used alone or used as a mixed solvent. As the electrolyte solution, an electrolyte solution in which a lithium salt such as LiPF₆, LiSbF₆, LiBF₄, LiClO₄, or LiAlO₄ is dissolved in any of these solvents is used. In a nickel hydrogen secondary battery, a potassium hydroxide aqueous solution can be used as the electrolyte solution. The secondary battery can be obtained in such a way that a positive electrode plate and a negative electrode plate sectioned by the separator are arranged in a spiral shape or in a multilayer structure and accommodated in a case or the like.

The binder for a secondary battery electrode disclosed herein is excellent in toughness of the binder applied film after the immersion in the electrolyte solution and the secondary battery electrode composite layer obtained using the electrode slurry including the binder exhibits the resistance against the electrolyte solution. In addition, the secondary battery including the electrode obtained using the binder can have excellent integrity and exhibits the excellent durability (cycle characteristic) even after the repeated charging and discharging; thus, the secondary battery is suitable for the use on vehicles or the like.

### EXAMPLES

The present invention will hereinafter be described in detail based on Examples. Note that the present invention is not limited by these Examples. In the following description, “parts” and “%” mean “parts by mass” and “mass %”, respectively unless otherwise stated.

In the following Examples, the carboxyl group-containing polymer salt is evaluated in accordance with a method given below.

### <<Manufacture of Carboxyl Group-Containing Polymer Salt>>

### (Measurement of Particle Diameter (Water-Swelling Particle Diameter) in Aqueous Medium)

Into a container of 100 cc, 0.25 g of the powder of the carboxyl group-containing crosslinked polymer salt and 49.75 g of ion exchange water were weighed and put, and the container was set to a planetary stirrer (“Awatori Rentaro” AR-250, manufactured by THINKY CORPORATION). Next, stirring (rotating speed 2,000 rpm/revolving speed 800 rpm, 7 minutes) and defoaming (rotating speed 2,200 rpm/revolving speed 60 rpm, 1 minute) processes were performed, so that a hydrogel in which a carboxyl group-containing crosslinked polymer salt was swelled with water was manufactured.

Next, the hydrogel was subjected to particle size distribution measurement with a laser diffraction/scattering type particle size analyzer (Microtrac MT-3300EXII, manufactured by MicrotracBEL Corp.) in which ion exchange water was used as a dispersion medium. While an excessive amount of dispersion medium circulated in the hydrogel, another hydrogel was added in an amount by which the suitable scattering light intensity can be obtained; then, it was found out that the particle size distribution shape measured after several minutes was stabilized. After the stabilization was confirmed, the particle size distribution measurement was conducted and the volume-based median diameter (D50) was obtained as a representative value of the particle diameter.

### Manufacture Example 1: Manufacture of Carboxyl Group-Containing Crosslinked Polymer Salt R-1

In the polymerization, a reactor with a stirring blade, a thermometer, a reflux cooler, and a nitrogen introduction tube was used.

In the reactor, 567 parts of acetonitrile, 2.2 parts of ion exchange water, 100 parts of acrylic acid (hereinafter referred to as “AA”), 0.9 parts of trimethylol propane diallyl ether (product name “NEOALLYL T-20”, manufactured by OSAKA SODA CO., LTD.), and triethyl amine corresponding to 1.0 mol % of the AA were prepared. After the inside of the reactor was substituted with nitrogen sufficiently, the temperature was increased so that the internal temperature became 55° C. After it was confirmed that the internal temperature became stable at 55° C., 0.040 parts of 2,2′-azobis(2,4-dimethyl valeronitrile) (product name “V-65”, manufactured by FUJIFILM Wako Pure Chemical Corporation) was added as a polymerization initiator; then, white turbidness was observed in a reaction solution and this point was used as the polymerization initiation point. Note that the monomer concentration was calculated as 15%. After 12 hours passed from the polymerization initiation point, the cooling of the polymerization reaction solution was started, and after the internal temperature decreased to 25° C., 52.4 parts of the powder of lithium hydroxide monohydrate (hereinafter referred to as “LiOH·H₂O”) was added. After the addition, the mixture was stirred continuously for 12 hours under room temperature, and a polymerization reaction solution in a slurry form in which particles of the carboxyl group-containing crosslinked polymer salt R-1 (lithium salt, neutralization degree 90 mol %) were diffused in the medium was obtained.

After the obtained polymerization reaction solution was subjected to centrifugal separation to make the polymer precipitate, the supernatant was removed. Then, after the precipitate was diffused again in acetonitrile whose weight is the same as the weight of the polymerization reaction solution, the polymer particles were precipitated by the centrifugal separation and the supernatant was removed; this cleaning operation was repeated twice. After the precipitate was collected, a drying process was performed for three hours at 80° C. under a reduced-pressure condition to remove the volatile component; thus, the powder of the carboxyl group-containing crosslinked polymer salt R-1 was obtained. Since the carboxyl group-containing crosslinked polymer salt R-1 has a moisture absorbing property, the carboxyl group-containing crosslinked polymer salt R-1 was airtightly kept in a container with a water vapor barrier property. Note that when the powder of the carboxyl group-containing crosslinked polymer salt R-1 was subjected to IR measurement and the neutralization degree was obtained based on the intensity ratio between the peak derived from C—O of the carboxylic acid and the peak derived from C═O of lithium carboxylate, the value was equal to the calculation value from the preparation, which was 90 mol %. The particle diameter in the aqueous medium was 1.52 μm.

### Manufacture Examples 2 to 7 and Comparative Manufacture Example 1: Carboxyl Group-Containing Crosslinked Polymer Salts R-2 to R-7, and Carboxyl Group-Containing Non-Crosslinked Polymer Salt R-8

The operation similar to that in Manufacture Example 1 was performed except that the kind and preparation amount of each raw material were set in accordance with Table 1, and thus polymerization reaction solutions containing the carboxyl group-containing crosslinked polymer salts R-2 to R-7, and the carboxyl group-containing non-crosslinked polymer salt R-8 were obtained.

Next, the operation similar to that in Manufacture Example 1 was performed regarding each polymerization reaction solution, and thus the carboxyl group-containing crosslinked polymer salts R-2 to R-7, and the carboxyl group-containing non-crosslinked polymer salt R-8 were obtained. Each polymer salt was kept airtightly in the container with the water vapor barrier property.

The physical property value of each obtained polymer salt was measured similarly to Manufacture Example 1 and the results are shown in Table 1.

TABLE 1

| | | | Manufacture Example/ | | | | | | | |
|---|---|---|---|---|---|---|---|---|---|---|
| | | | Comparative Manufacture Example No. | | | | | | | |
| | | | Manu- | Manu- | Manu- | Manu- | Manu- | Manu- | Manu- | Compar- |
| | | | facture | facture | facture | facture | facture | facture | facture | ative |
| | | | Exam- | Exam- | Exam- | Exam- | Exam- | Exam- | Exam- | Manufacture |
| | | | ple 1 | ple 2 | ple 3 | ple 4 | ple 6 | ple 6 | ple 7 | Example 1 |
| Carboxyl group- | | | R-1 | R-2 | R-3 | R-4 | R-5 | R-6 | R-7 | R-8 |
| containing polymer salt | | | | | | | | | | |
| Preparation | Ethylene | AA | 100.0 | 90.0 | 60.0 | 100.0 | 100.0 | 100.0 | 100.0 | 100.0 |
| [parts] | unsaturated | | | | | | | | | |
| | carboxylic | | | | | | | | | |
| | acid monomer | | | | | | | | | |
| | Other monomer | HEAA | | 10.0 | 40.0 | | | | | |
| | Crosslinkable | T-20 [parts] | 0.90 | 0.90 | 0.90 | 0.90 | 0.90 | 0.90 | | |
| | monomer | UN-6200 [parts] | | | | | | | 2.00 | |
| | | Amount of | 0.30 | 0.32 | 0.36 | 0.30 | 0.30 | 0.30 | 0.07 | 0.0 |
| | | use [mol%] | | | | | | | | |
| | Basic compound | TEA [mol %] | 1.0 | 1.0 | 1.0 | 1.0 | 1.0 | 1.0 | 1.0 | 1.0 |
| | Polymerizing | Ion exchange | 2.2 | 2.2 | 2.2 | 2.2 | 2.2 | 2.2 | 2.2 | 2.2 |
| | solvent | water | | | | | | | | |
| | | Acetonitrile | 567 | 567 | 567 | 567 | 567 | 567 | 567 | 567 |
| | Polymerization | V-65 | 0.040 | 0.040 | 0.040 | 0.040 | 0.040 | 0.040 | 0.040 | 0.040 |
| | initiator | | | | | | | | | |
| | Process | LiOH•H₂O | 52.4 | 47.2 | 31.4 | 40.8 | | | 52.4 | 52.4 |
| | neutralization | Na₂CO₃ | | | | | 66.9 | | | |
| | | K₂CO₃ | | | | | | [symbol] | | |

| Initial monomer | | 15% | 15% | 15% | 15% | 15% | 15% | 15% | 15% |
|---|---|---|---|---|---|---|---|---|---|
| concentration [wt %] | | | | | | | | | |
| Neutralization | Type | Li | Li | Li | Li | Na | K | Li | Li |
| salt | Neutralization | 90 | 90 | 90 | 70 | 90 | 90 | 90 | 90 |
| | degree [mol %] | | | | | | | | |

| | | | | | | | | |
|---|---|---|---|---|---|---|---|---|
| Water-swelling particle | 1.52 | 1.54 | 1.70 | 1.58 | 1.55 | 1.51 | 1.99 | Dissolving |
| diameter [μm] | | | | | | | | |

[symbol]

indicates data missing or illegible when filed

The details of the compounds used in Table 1 are shown below.
AA: Acrylic acid
HEAA: N-hydroxyethyl acrylamide
T-20: Trimethylol propane diallyl ether (product name “NEOALLYL T-20”, manufactured by OSAKA SODA CO., LTD.)
UN-6200: bifunctional urethane acrylate (product name “ART RESIN UN-6200”, manufactured by Negami Chemical Industrial Co., Ltd.)
TEA: Triethyl amine
V-65:2,2′-azobis(2,4-dimethyl valeronitrile) (product name “V-65”, manufactured by
FUJIFILM Wako Pure Chemical Corporation)
LiOH·H₂O: Hydroxide·monohydrate
Na₂CO₃: Sodium carbonate
K₂CO₃: Potassium carbonate

### Example 1

### (Manufacture of Binder Applied Film)

In the container, the carboxyl group-containing crosslinked polymer salt R-1, styrene/butadiene latex (SBR), carboxymethyl cellulose sodium (CMC), polyethylene imine (product name “EPOMIN SP-200”, manufactured by NIPPON SHOKUBAI CO., LTD., with a weight-average molecular weight of 10,000, which is hereinafter also referred to as “PEI-1”), and ion exchange water were added in the parts shown in Table 2 and mixed. The mixture was then preliminarily dispersed with a disperser, and then the dispersion was performed for 15 seconds with a thin-film spin system mixer (FM-56-30, manufactured by PRIMIX Corporation) under a condition of a circumferential speed of 20 m/s; thus, a binder aqueous solution was obtained.

After that, the binder aqueous solution was poured into a dispotray and dried at 40° C. for 20 hours and then additionally dried in vacuum at 80° C. for 12 hours.

The binder applied film obtained after the drying was punched into a size of 1.0 cm×6.0 cm to manufacture a test piece, and the toughness and the resistance against the electrolyte solution were measured.

### (Toughness of Binder Applied Film)

Regarding the test piece manufactured by punching the binder applied film, the Young's modulus [GPa] was measured by performing a tensile test at a rate of 10 mm/min using a tensile tester (TENSILON, RTC-1210A, manufactured by ORIENTEC). As a result, the Young's modulus was 1.76 GPa.

In addition, the test piece used in the evaluation of the electrolyte solution swelling property was also subjected to the tensile test under the similar condition and the Young's modulus was measured. As a result, the Young's modulus was 1.47 GPa and the toughness based on the following criteria was evaluated as “A”.

Note that as the Young's modulus of the binder applied film after the immersion in the electrolyte solution is higher, the toughness of the electrode composite layer is higher and the cycle characteristic can be improved.

### (Criteria on Toughness)

A: The Young's modulus after the immersion in the electrolyte solution is 1.30 GPa or more
B: The Young's modulus after the immersion in the electrolyte solution is 1.20 GPa or more and less than 1.30 GPa
C: The Young's modulus after the immersion in the electrolyte solution is less than 1.20 GPa

### (Resistance of Binder Applied Film Against Electrolyte Solution)

The obtained test piece was immersed in the electrolyte solution containing ethylene carbonate (EC) and dimethyl carbonate (DMC) in a mass ratio of EC:DMC=1:3 and left at rest for two hours at 40° C. Then, the test piece was extracted from the electrolyte solution, the surface was wiped, and the electrolyte solution swelling degree was measured.

Here, the method for measuring the electrolyte solution swelling degree is described below.

When the weights of the test piece before and after the immersion in the electrolyte solution were [W₀(g)] and [W₁(g)], respectively, the electrolyte solution swelling degree was obtained in accordance with the following formula:

$$Electrolyte solution swelling degree ( mass \% ) = ( {W}_{1} ) / ( {W}_{0} ) \times 100$$

In accordance with the above formula, the electrolyte solution swelling degree was 110% and the resistance against the electrolyte solution was evaluated as “A” based on the following criteria.

Note that as the electrolyte solution swelling degree of the binder applied film is lower, the electrode composite layer absorbs the electrolyte solution component less easily and swells less easily in the electrolyte solution.

### (Criteria of Resistance Against Electrolyte Solution)

A: Electrolyte solution swelling degree is less than 111%.
B: Electrolyte solution swelling degree is 111% or more and less than 116%.
C: Electrolyte solution swelling degree is 116% or more and less than 121%.
D: Electrolyte solution swelling degree is 121% or more.

### Examples 2 to 13 and Comparative Examples 1 and 2

The operation similar to that of Example 1 was performed except the mixing was conducted in accordance with Table 2, so that the binder applied film was manufactured and the toughness and the resistance against the electrolyte solution were evaluated. The results are shown in Table 2.

### Example 1

### (Preparation of Composition for Electrode Mixture Layer)

As the active material, synthetic graphite (product name “SCMG-CF”, manufactured by Showa Denko K.K.) and SiO (manufactured by OSAKA Titanium technologies, 5 μm) were used. As the binder, a mixture of the carboxyl group-containing crosslinked polymer salt R-1, styrene/butadiene rubber (SBR), and carboxymethyl cellulose sodium (CMC) were used. In addition, as the multifunctional cationic group-containing compound, polyethylene imine (PEI-1) was used.

Graphite, the Si-based active material, R-1, SBR, CMC, and PEI were mixed in a planetary mixer (HIVIS MIX model 2P-03, manufactured by PRIMIX Corporation) in a mass ratio of graphite:Si-based active material:R-1:SBR:CMC:PEI=76.8:19.2:1.0:2.0:1.0:0.05 (solid content) so that the solid content concentration of the composition for an electrode mixture layer became 53 mass % using water as a diluting solvent, and the mixture was mixed for 1 hour and 30 minutes; thus, the composition for an electrode mixture layer in the slurry state (electrode slurry) was prepared.

### (Manufacture of Negative Electrode Plate)

Next, the electrode slurry was applied on a current collector (copper foil) with a thickness of 16.5 μm using a variable applicator, and drying was performed for 15 minutes at 80° C. in a forced-air drier; thus, the mixture layer was formed. After that, the mixture layer was rolled so that the thickness became 50±5 μm and the mixture density became 1.60±0.10 g/cm³, and then, the mixture layer was punched into a size of 1.0 cm×6.0 cm for a peeling strength test and into a square with a length of 3 cm for battery evaluation; thus the negative electrode plate was obtained.

### (Manufacture of Positive Electrode Plate)

In an N-methylpyrrolidone (NMP) solvent, 100 parts of LiNi_{0.5}Co_{0.2}Mn_{0.3}O₂ (NCM) as the positive electrode active material and 2 parts of acetylene black were mixed and added, and 4 parts of polyvinylidene fluoride (PVDF) was mixed therein as the binder for a positive electrode: thus, a composition for a positive electrode composite layer was prepared. The composition for a positive electrode composite layer was applied and dried on an aluminum current collector (thickness: 20 μm), so that the mixture layer was formed. After that, the mixture layer was rolled so that the thickness became 125 μm and the mixture density became 3.0 g/cm³, and then, the mixture layer was punched into a square with a length of 3 cm; thus the positive electrode plate was obtained.

### (Preparation of Electrolyte Solution)

To a mixed solvent including ethylene carbonate (EC) and dimethyl carbonate (DMC) (EC:DMC=3:7 in volume ratio), vinylene carbonate (VC) was added by 1 mass % and fluoroethylene carbonate (FEC) was added by 2 mass %, and then LiPF₆ was dissolved by 1.2 mol/L; thus, a nonaqueous electrolyte was prepared.

### (Manufacture of Secondary Battery)

In the structure of the battery, an electrode body in which a lead terminal was attached to each of the positive and negative electrodes, with the electrodes facing each other through a separator (made of polyethylene and having a film thickness of 16 μm and a porosity of 47%) was put into an aluminum laminate as a battery package and the solution was injected thereinto and then, the battery was sealed; thus, a test battery was obtained. Note that the design capacity of this test battery is 50 mAh. As the design capacity of the battery, the design was conducted based on a charge end voltage to 4.2 V.

### <Evaluation on Cycle Characteristic>

The lithium ion secondary battery of the laminate type cell manufactured above was charged and discharged at a charging and discharging rate of 0.1 C under a condition of 2.5 to 4.2 V by CC discharging in an environment of 45° C.; thus, an initial capacity Co was measured. In addition, charging and discharging were repeated at a charging and discharging rate of 0.5 C under a condition of 2.5 to 4.2 V by CC discharging in an environment of 25° C., and a capacity C₁₀₀ after 100 cycles was measured.

Here, the cycle characteristic (ΔC) was obtained by the following formula:

$$Δ C = {C}_{100} / {C}_{0} \times 100 ( \% )$$

ΔC calculated in accordance with the above formula was 86.4% and the cycle characteristic based on the following criteria was evaluated as “A”.

Note that the larger value of AC means the superior cycle characteristic.

### (Criteria of Cycle Characteristic)

A: Charging and discharging capacity retention is 86.0% or more.
B: Charging and discharging capacity retention is 85.0% or more and less than 86.0%.
C: Charging and discharging capacity retention is 84.0% or more and less than 85.0%.
D: Charging and discharging capacity retention is less than 84.0%.

### Examples 2 to 13 and Comparative Examples 1 and 2

The operation similar to that of Example 1 was performed except the mixing was conducted in accordance with Table 2, so that the electrode slurry was prepared and the cycle characteristic of the battery including the negative electrode plate obtained using the electrode slurry was evaluated. The results are shown in Table 2.

TABLE 2

| | | | | | Example/Comparative Example No. | | | | | | |
|---|---|---|---|---|---|---|---|---|---|---|---|
| | | | | | Exam- | Exam- | Exam- | Exam- | Exam- | Exam- | Exam- |
| | | | | | ple 1 | ple 2 | ple 3 | ple 4 | ple 5 | ple 6 | ple 7 |
| Compo- | Active | | Synthetic | Parts | 78.8 | [symbol] | [symbol] | [symbol] | [symbol] | [symbol] | 76.8 |
| sition | material | | graphite | | | | | | | | |
| for | | | SiO | Parts | 19.2 | 19.2 | 19.2 | 19.2 | 19.2 | 19.2 | 19.2 |
| electrode | Compo- | Binder | Carboxyl | Type | R-1 | R-1 | R-1 | R-1 | R-1 | R-2 | R-3 |
| mixture | sition | | group | | | | | | | | |
| [symbol] | for | | containing | Parts | 1.0 | 1.0 | 1.0 | 1.0 | 1.0 | 1.0 | 1.0 |
| slurry) | binder | | [symbol] | | | | | | | | |
| | [symbol] | | polymer | | | | | | | | |
| | | | salt | | | | | | | | |
| | | | SBR | Parts | 2.0 | 2.0 | 2.0 | 1.9 | 2.0 | 2.0 | 2.0 |
| | | | CMC | Parts | 1.0 | 1.0 | 1.0 | 1.0 | 1.0 | 1.0 | 1.0 |

| | | | | | | | | |
|---|---|---|---|---|---|---|---|---|
| [symbol] | Type | PEI-1 | PEI-2 | PEI-3 | PEI-1 | PEI-1 | PEI-1 | PEI-1 |
| containing | Molecular | 10,000 | [symbol] | 20,000 | 10,000 | 10,000 | 10,000 | 10,000 |
| compound | weight | | | | | | | |
| | Parts | 0.05 | 0.05 | 0.05 | 0.08 | 0.02 | 0.05 | 0.05 |
| | Molar ratio | 0.84 | 0.84 | 0.84 | 1.3 | 0.34 | 0.53 | 1.4 |
| | of [symbol] | | | | | | | |
| | group to | | | | | | | |
| | carboxyl group | | | | | | | |
| | in polymer | | | | | | | |

| | | | | | | | |
|---|---|---|---|---|---|---|---|
| Ion exchange water | 130 | 130 | 130 | 130 | 130 | 130 | 130 |
| Total of preparation | 134.0 | 134.0 | 134.0 | 134.0 | 134.0 | 134.0 | 134.0 |
| Solid content | 2.0% | 2.0% | 2.0% | 2.0% | 2.0% | 2.0% | 2.0% |
| concentration [symbol] | | | | | | | |

| Ion exchange water | | 86 | 86 | 86 | 86 | 86 | 86 | 86 |
|---|---|---|---|---|---|---|---|---|
| Total of preparetion | | 186.0 | 186.0 | [symbol] | 186.0 | 186.0 | [symbol] | 186.0 |
| Solid [symbol] | | [symbol] | 53% | [symbol] | 53% | 53% | 53% | 53% |
| concentration [symbol] | | | | | | | | |
| Toughness of binder | Young's | [symbol] | 1.99 | 2.07 | 1.75 | 1.72 | 1.75 | [symbol] |
| applied film | modulus | | | | | | | |
| | [GPa] [symbol] | | | | | | | |
| | immersion in | | | | | | | |
| | [symbol] solution | | | | | | | |
| | Young's | 1.47 | 1.38 | 1.54 | 1.48 | 1.35 | 1.45 | 1.25 |
| | modulus | | | | | | | |
| | [GPa] | | | | | | | |
| | after | | | | | | | |
| | immersion in | | | | | | | |
| | electrotype | | | | | | | |
| | solution | | | | | | | |
| | Evolution | A | A | A | A | A | A | B |
| | result | | | | | | | |
| Resistance of binder | Electrolyte | [symbol] | [symbol] | [symbol] | [symbol] | [symbol] | [symbol] | [symbol] |
| applied [symbol] | solution [symbol] | | | | | | | |
| electrolyte solution | degree [%] | | | | | | | |
| | [symbol] result | A | B | A | A | B | B | C |
| [symbol] characteristic | Capacity | 86.4 | 85.8 | 85.0 | 86.0 | 85.2 | 86.0 | 84.1 |

| | | | | | | | |
|---|---|---|---|---|---|---|---|
| retention | | | | | | | |
| [symbol] | | | | | | | |
| [symbol] result | A | B | B | A | B | A | C |

| | | | | | Example/Comparative Example No. | | | | | | | |
|---|---|---|---|---|---|---|---|---|---|---|---|---|
| | | | | | | | | | | | Compar- | Compar- |
| | | | | | | | | | | | ative | ative |
| | | | | | Exam- | Exam- | Exam- | Exam- | Exam- | Exam- | Exam- | Exam- |
| | | | | | ple 8 | ple 9 | ple 10 | ple 11 | ple 12 | ple 13 | ple 1 | ple 2 |
| Compo- | Active | | Synthetic | Parts | [symbol] | [symbol] | [symbol] | [symbol] | [symbol] | 76.8 | [symbol] | [symbol] |
| sition | material | | graphite | | | | | | | | | |
| for | | | SiO | Parts | 19.2 | 19.2 | 19.2 | 19.2 | 19.2 | 19.2 | 19.2 | 19.2 |
| electrode | Compo- | Binder | Carboxyl | Type | R-4 | R-5 | R-6 | R-7 | R-1 | R-1 | R-1 | R-8 |
| mixture | sition | | group | | | | | | | | | |
| [symbol] | for | | containing | Parts | 1.0 | 1.0 | 1.0 | 1.0 | 1.0 | 1.0 | 1.0 | 1.0 |
| slurry) | binder | | [symbol] | | | | | | | | | |
| | [symbol] | | polymer | | | | | | | | | |
| | | | salt | | | | | | | | | |
| | | | SBR | Parts | 2.0 | 2.0 | 2.0 | 2.0 | 2.0 | 2.0 | 2.0 | 2.0 |
| | | | CMC | Parts | 1.0 | 1.0 | 1.0 | 1.0 | 1.0 | 1.0 | 1.0 | 1.0 |

| | | | | | | | | | |
|---|---|---|---|---|---|---|---|---|---|
| [symbol] | Type | PEI-1 | PEI-1 | PEI-1 | PEI-1 | PEI-1 | PEI-1 | PEDA | PETA |
| containing | Molecular | 10,000 | 10,000 | 10,000 | 10,000 | 430 | 440 | | 10,000 |
| compound | weight | | | | | | | | |
| | Parts | 0.05 | 0.05 | 0.05 | 0.05 | 0.05 | 0.05 | | 0.05 |
| | Molar ratio | [symbol] | 0.84 | 0.84 | 0.84 | 0.17 | 0.25 | 0.0 | 0.84 |
| | of [symbol] | | | | | | | | |
| | group to | | | | | | | | |
| | carboxyl group | | | | | | | | |
| | in polymer | | | | | | | | |

| | | | | | | | | |
|---|---|---|---|---|---|---|---|---|
| Ion exchange water | 130 | 130 | 130 | 130 | 130 | 130 | 130 | 130 |
| Total of preparation | 134.0 | 134.0 | 134.0 | 134.0 | 134.0 | 134.0 | 134.0 | 134.0 |
| Solid content | 2.0% | 2.0% | 2.0% | 2.0% | 2.0% | 2.0% | 2.0% | 2.0% |
| concentration [symbol] | | | | | | | | |

| Ion exchange water | | 86 | 86 | 86 | 86 | 86 | 86 | 86 | 86 |
|---|---|---|---|---|---|---|---|---|---|
| Total of preparetion | | 186.0 | 186.0 | 186.0 | [symbol] | 186.0 | 186.0 | 186.0 | 186.0 |
| Solid [symbol] | | 53% | 53% | [symbol] | [symbol] | [symbol] | [symbol] | 53% | [symbol] |
| concentration [symbol] | | | | | | | | | |
| Toughness of binder | Young's | 1.76 | 1.74 | 1.74 | 1.75 | [symbol] | 1.64 | 1.51 | 1.31 |
| applied film | modulus | | | | | | | | |
| | [GPa] [symbol] | | | | | | | | |
| | immersion in | | | | | | | | |
| | [symbol] solution | | | | | | | | |
| | Young's | [symbol] | 1.45 | 1.46 | 1.46 | 1.27 | 1.28 | [symbol] | [symbol] |
| | modulus | | | | | | | | |
| | [GPa] | | | | | | | | |
| | after | | | | | | | | |
| | immersion in | | | | | | | | |
| | electrotype | | | | | | | | |
| | solution | | | | | | | | |
| | Evolution | A | A | A | A | B | B | C | C |
| | result | | | | | | | | |
| Resistance of binder | Electrolyte | [symbol] | [symbol] | [symbol] | [symbol] | [symbol] | [symbol] | [symbol] | [symbol] |
| applied [symbol] | solution [symbol] | | | | | | | | |
| electrolyte solution | degree [%] | | | | | | | | |
| | [symbol] result | A | A | A | B | B | B | C | D |
| [symbol] characteristic | Capacity | 86.2 | 86.0 | 86.2 | 85.6 | 84.0 | 84.5 | 82.8 | 78.0 |

| | | | | | | | | |
|---|---|---|---|---|---|---|---|---|
| retention | | | | | | | | |
| [symbol] | | | | | | | | |
| [symbol] result | A | A | A | B | C | C | D | D |

[symbol]

indicates data missing or illegible when filed

The details of the compounds used in Table 2 are shown below.
CMC: Carboxymethyl cellulose sodium
SBR: Styrene butadiene rubber
PEI-1: Polyethylene imine (product name “EPOMIN SP-200”, manufactured by NIPPON
SHOKUBAI CO., LTD. with a number-average molecular weight of 10,000 based on the method of the elevation of boiling point)
PEI-2: Polyethylene imine (product name “EPOMIN SP-006”, manufactured by NIPPON
SHOKUBAI CO., LTD. with a number-average molecular weight of 600 based on the method of the elevation of boiling point)
PEI-3: Polyethylene imine (product name “EPOMIN P-1000”, manufactured by NIPPON SHOKUBAI CO., LTD. with a number-average molecular weight of 70,000 based on the viscometry)
PEDA: Polyoxypropylene diamine (product name “JEFFAMNINE D-400”, manufactured by HUNTSMAN, with a weight-average molecular weight of 430 based on the GPC method)
PETA: Trimethylol propane poly(oxypropylene)triamine (product name “JEFFAMNINE T-403”, manufactured by HUNTSMAN, with a weight-average molecular weight of 440 based on the GPC method)

### <<Evaluation Result>>

As is clear from the results of Examples 1 to 13, the binder for a secondary battery electrode according to the present invention is excellent in toughness of the binder applied film after the immersion in the electrolyte solution and the composition for a secondary battery electrode mixture layer (electrode slurry) including the binder for a secondary battery electrode according to the present invention is excellent in the resistance of the secondary battery electrode mixture layer against the electrolyte solution and the cycle characteristic of the secondary battery.

In particular, when attention is paid to the molecular weight of the multifunctional cationic group-containing compound, the cycle characteristic of the secondary battery was superior in the case where the molecular weight was 10,000 (Example 1) to that in the case where the molecular weight was 70,000 (Example 3) or the molecular weight was 600 (Example 2).

It is estimated this is because in the case of using the multifunctional cationic group-containing compound with a molecular weight of 70,000, the dispersion stability of the active material in the electrode slurry is deteriorated and in the case of using the multifunctional cationic group-containing compound with a molecular weight of 600, the crosslinking between the binders becomes insufficient.

Additionally, the resistance of the secondary battery electrode mixture layer against the electrolyte solution and the cycle characteristic of the secondary battery were much superior in the case where the molar ratio of the cationic group to the carboxyl group in the crosslinked polymer is in the range of 0.84 to 1.3 (Examples 1 and 4) to those in the case where the molar ratio is in the range of 0.17 to 0.34 (Examples 5, 12, and 13) as the multifunctional cationic group-containing compound.

On the other hand, if the multifunctional cationic group-containing compound is not included, the toughness of the binder applied film, the resistance against the electrolyte solution, and the cycle characteristic were all inferior (Comparative Example 1).

In addition, in the case of using the carboxyl group-containing non-crosslinked polymer salt, the toughness of the binder applied film, the resistance against the electrolyte solution, and the cycle characteristic were all inferior to those in the case of using the carboxyl group-containing crosslinked polymer salt (Comparative Example 2).

### INDUSTRIAL APPLICABILITY

The binder for a secondary battery electrode disclosed herein is excellent in toughness of the binder applied film after the immersion in the electrolyte solution, and the secondary battery electrode mixture layer obtained using the electrode slurry including the binder exhibits the resistance against the electrolyte solution. Moreover, the secondary battery including the electrode obtained using the binder described above can secure the suitable integrity and exhibits the excellent durability (cycle characteristic) even after the repeated charging and discharging; thus, it is expected to contribute to the higher capacity of on-vehicle secondary batteries and the like.

The binder for a secondary battery electrode according to the present invention can be suitably used for a nonaqueous electrolyte secondary battery electrode in particular, and above all, is useful for a nonaqueous electrolyte lithium ion secondary battery with high energy density.

1. A binder for a secondary battery electrode, comprising a carboxyl group-containing crosslinked polymer or a salt thereof, wherein at least a part of the carboxyl group is a functional group used to couple with an organic compound having two or more cationic groups.

2. The binder for a secondary battery electrode according to claim 1, further comprising an organic compound having two or more cationic groups with reactivity to the carboxyl group (this organic compound is hereinafter referred to as “multifunctional cationic group-containing compound”).

3. The binder for a secondary battery electrode according to claim 2, wherein the multifunctional cationic group-containing compound is contained so that a molar ratio of the cationic group to the carboxyl group in the crosslinked polymer is 0.05 or more and 3.0 or less.

4. The binder for a secondary battery electrode according to claim 2, wherein the multifunctional cationic group-containing compound has a molecular weight of 300 or more and 100,000 or less.

5. The binder for a secondary battery electrode according to claim 3, wherein the multifunctional cationic group-containing compound has a molecular weight of 300 or more and 100,000 or less.

6. The binder for a secondary battery electrode according to claim 2, wherein the multifunctional cationic group-containing compound includes at least one kind selected from the group consisting of polyethylene imine, a polyethylene imine derivative, and polyether amine.

7. The binder for a secondary battery electrode according to claim 1, wherein the carboxyl group-containing crosslinked polymer contains 50 mass % or more and 100 mass % or less of a structural unit derived from an ethylene unsaturated carboxylic acid monomer relative to all structural units of the carboxyl group-containing crosslinked polymer.

8. The binder for a secondary battery electrode according to claim 6, wherein the carboxyl group-containing crosslinked polymer contains 50 mass % or more and 100 mass % or less of a structural unit derived from an ethylene unsaturated carboxylic acid monomer relative to all structural units of the carboxyl group-containing crosslinked polymer.

9. The binder for a secondary battery electrode according to claim 6, wherein the crosslinked polymer is a crosslinked polymer obtained by polymerizing a monomer composition including a non-crosslinkable monomer and a crosslinkable monomer (however, different from the multifunctional cationic group-containing compound).

10. The binder for a secondary battery electrode according to claim 9, wherein the crosslinkable monomer is used by 0.001 mol % or more and 2.5 mol % or less relative to a total quantity of the non-crosslinkable monomer.

11. The binder for a secondary battery electrode according to claim 1, wherein after neutralization to a neutralization degree of 80 to 100 mol %, a particle diameter of the crosslinked polymer that is measured in an aqueous medium is a volume-based median diameter of 0.1 μm or more and 10.0 μm or less.

12. The binder for a secondary battery electrode according to claim 6, wherein after neutralization to a neutralization degree of 80 to 100 mol %, a particle diameter of the crosslinked polymer that is measured in an aqueous medium is a volume-based median diameter of 0.1 μm or more and 10.0 μm or less.

13. A composition for a secondary battery electrode mixture layer, comprising the binder for a secondary battery electrode according to claim 6, an active material, and water.

14. The composition for a secondary battery electrode mixture layer according to claim 13, wherein the active material includes a silicon-based active material.

15. A secondary battery electrode comprising a mixture layer formed of the composition for a secondary battery electrode mixture layer according to claim 13 on a surface of a current collector.

16. A secondary battery comprising the secondary battery electrode according to claim 15.
